(19) United States
(12) Patent Application Publication
(10) Pub. No.: US 2003/0172170 A1
(43) Pub. Date: Sep. 11, 2003

(54) Providing multiple ISP access to devices behind NAT

(76) Inventors: Gerald R. Johnson, Cataumet, MA (US); Kevin J. Burak, North Easton, MA (US)

Correspondence Address: MOTOROLA, INC., 1303 EAST ALGONQUIN ROAD, IL01/3RD, SCHAUMBURG, IL, 60196

(21) Appl. No.: 10/093,860

(22) Filed: Mar. 8, 2002

(51) Int. Cl. G06F 15/16

(52) U.S. Cl. 709/230; 709/245

(57) ABSTRACT

A communications system and method is provided that includes multiple networked devices connected in a local area network and connected, via a gateway having enhanced functionality, to a wide area network such as the Internet using one or more Internet service providers. The system includes a source routing device (130), at least two networked customer premise equipment devices (118, 120), a gateway (123) for controlling communication between the source routing device (130) and the customer premise equipment devices (118, 120) and an address server (132) for providing the gateway (123) with at least two dynamically assigned Internet protocol addresses corresponding to different Internet service providers (138, 140) to enable each of the customer premise equipment devices (118, 120) to establish simultaneous connections with the different Internet service providers (138, 140).

### FIELD OF THE INVENTION

The present invention relates generally to computer networking and, more particularly, to accessing multiple Internet service providers over a singlewide area network connection.

### BACKGROUND OF THE INVENTION

The explosive growth of the internet during the past several years has created a situation where many household are now purchasing their first computer and establishing an internet connection, either through dial-up or some means of broadband connection such as cable, digital subscriber line (xDSL) or satellite. And, although personal computer (PC) purchases by first time owners have exploded, it is estimated that the number of households owning more than a single PC is one of the fastest growing segments of the market, estimated at over 20 million. As the number of households with PCs and multiple PCs has grown and as prices in networking equipment have fallen, new networking technologies have been developed to make installation of local area networks (LANs) in a home environment simple, fast and inexpensive.

Furthermore, it has become possible to cost-effectively share a single Internet connection with all the PCs in the household. This is accomplished by connecting the LAN to the Internet using a single gateway device. Typically, the gateway is either a router or a personal computer executing gateway software. The gateway includes network address translation (NAT) software, which generally is required to enable all the PCs in the network to share a single Internet connection. The ability to network multiple PCs together such that a single Internet connection may be shared is highly desirable. Unfortunately, however, existing networking technology allows only a single Internet service provider (ISP) to be accessed over that single Internet connection. As such, even though multiple PCs are part of the network, all the PC's are able to access the Internet through only a single Internet service provider (ISP). Therefore, a PC on the LAN wishing to access, for example, Earthlink is unable to do so if the chosen Internet provider is ATT Broadband, which uses a different provider for ISP service.

### BRIEF DESCRIPTION OF THE DRAWINGS

FIG. 1 shows a prior art communications network illustrating LAN and WAN interconnectivity;

FIG. 2 shows a communications network illustrating LAN and WAN interconnectivity in accordance with the present invention;

FIG. 3 shows a communication network illustrating LAN and WAN interconnectivity in accordance with an alternate embodiment of the present invention; and

FIGS. 4 and 5 are a flow diagram illustrating operation of the communications systems of FIGS. 2 and 3.

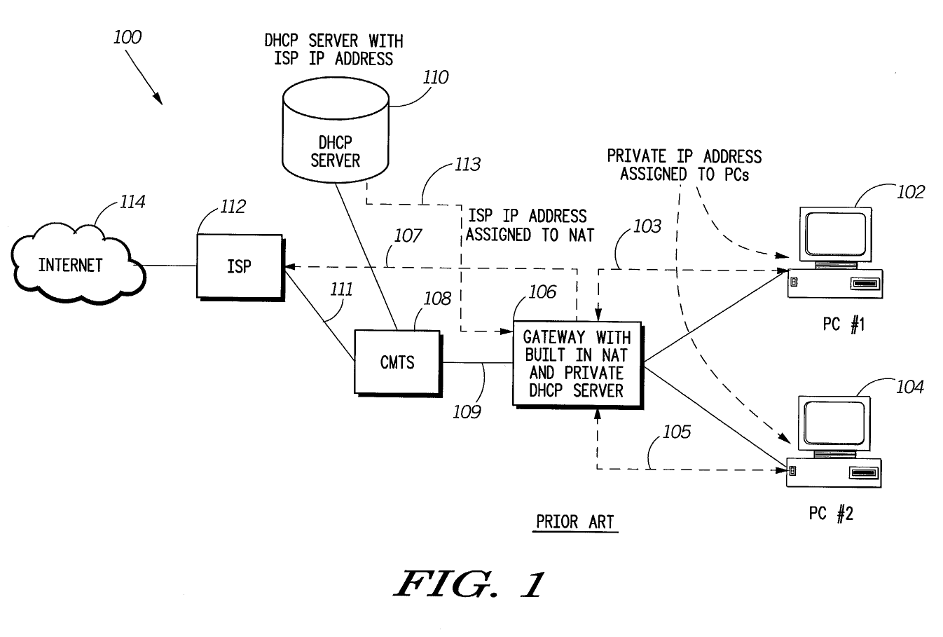

### DETAILED DESCRIPTION OF THE INVENTION

In accordance with one aspect of the invention, a communications system is provided that includes multiple customer premises equipment (CPE) devices configured in a local area network and connected, via a gateway having enhanced functionality, to a wide area network such as the internet, using one or more internet service providers. A particular advantage of such a system is the ability of each of the CPE devices to use its own selected ISP, rather than a preselected ISP chosen by default, for example, by a cable internet provider.

The gateway, in order to enable access to multiple ISPs, can be configured with or without network address translation (NAT) functionality. In a first configuration of the gateway in which the gateway does not include NAT, the gateway bridges all traffic to and from the cable modem termination system (CMTS) and the CPE devices. Accordingly, the gateway supports IP forwarding to enable the CPE devices on other gateway ports and other subnets to communicate. In an alternate configuration in which the Gateway includes NAT, the gateway translates and forwards all IP traffic to and from the CMTS and the CPE devices. NAT handles multiple IP addresses corresponding to the multiple ISPs used by the CPEs.

An exemplary network 100 consisting of a typical home or small office/home office (SOHO) LAN connected to the Internet is shown. Each of the PCs 102, 104 and/or any other CPE devices present on the LAN are connected to the gateway 106 through their respective network connections 103, 105. The connections maybe wireless or through some type of home wiring, as described above. For purposes of the present discussion, and by way of example only, the networked CPE devices hereafter will be referred to as PCs. However, it is to be noted that any device having networking capabilities may be connected to the network.

The gateway 106 maybe either a standalone PC running gateway software or a router of some sort, as typically used in connecting a LAN to the internet when sharing a broadband connection such as cable or xDSL. The gateway 106 includes NAT functionality and a private dynamic host control protocol (DHCP) server that is internal to the LAN. Each of the PCs 102, 104 connected to the gateway 106 are assigned a private IP address by the DHCP server. The PCs 102, 104 use the private IP addresses to only communicate internally with each other and with the gateway 106. That is, the private IP addresses assigned to each of the PCs 102 and 104 by the private DHCP server are not used to communicate with the Internet in the public space. Inherent to the functionality of the DHCP server, private IP addresses may change as PCs are added or removed from the LAN.

The gateway 106 in addition to providing network functionality to the PCs 102 and 104 on the LAN also communicates, via an ISP with a wide area network (WAN) such as the Internet through a communications link 109 connected to a device capable of source routing, such as a CMTS 108. The CMTS 108 maybe located, for example, at a cable provider or other multiple service operator (MSO), which is providing the actual physical connections 109, 111 between the LAN gateway 106 and the ISP 112. The CMTS 108 is interfaced to a public DHCP server 110 that provides dynamic IP addresses to the gateway 106 when the gateway 106 attempts to access the public network, such as the Internet 114 through an ISP 112 over connection 111.

The DHCP server 110 provides dynamic provisioning of IP addresses. Because currently there are only a finite number of IP addresses available, IP addresses my be allocated dynamically so that as one computer or network using a particular IP address releases that IP address, it is made available to the DHCP server to provide that IP address to another gateway or computer requiring access to the internet. By providing IP addresses to only those networks or PCs requiring their use, and releasing those IP addresses that are no longer used by PCs, IP addresses are recycled, thereby providing internet access to many systems using relatively fewer IP addresses.

Once the gateway 106 is assigned an IP address from the DHCP server 110 it is able to establish a connection 107 to the ISP 112. The NAT function of the gateway 106 then binds the private address of the PC that made the request for data from the Internet. As such, the data received from the Internet 114 through the ISP 112 into the gateway 106 is correctly routed to the particular PC that initiated the request for information.

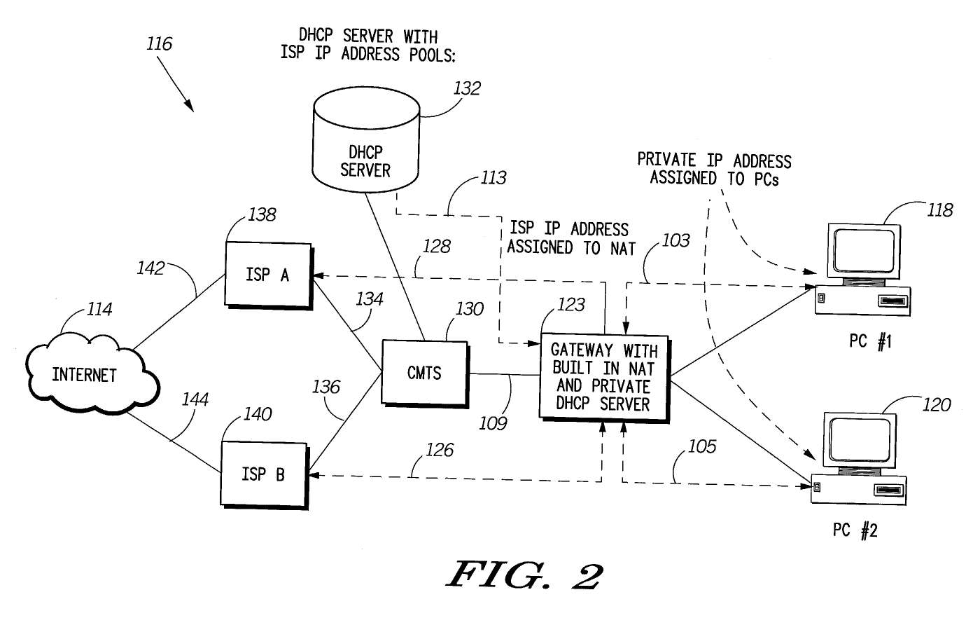

Referring to FIG. 2, a local area network 116 in a first aspect of the invention is illustrated. The private LAN 116 includes one or more PCs 118, 120 connected to a gateway 123 through connections 103, 105. The connections maybe wireless or through some type of home wiring networking system, such as a power line network phone line network, radio-frequency LANs, cable wiring and Ethernet.

The gateway 123 accesses a source routing device such as a CMTS 130 through connection 109. As mentioned above, the CMTS 130 maybe located, for example, at a cable provider or other multiple service operator (MSO), that provides the connections 128, 126 between the LAN gateway 123 and the ISPs 138, 140. The ISPs 138 and 140 then provide connection to the Internet 114 over connections 142, 144. The CMTS 130 accesses a DHCP server 132, which provides dynamic IP addresses to the gateway 123.

The gateway 123, upon receiving the IP address from the DHCP server 132, enables the NAT function in the gateway 123 to translate the private IP addresses of the PCs 118, 120 to operate using the assigned DHCP public IP address to access the internet. In particular, the NAT function in the gateway 123 binds the private address of the PC that made the request for data from the Internet. NAT is usually transparent to users on the network and operates as a translation device to enable network traffic received from the Internet, in response to requests made by computers on the LAN, to be routed to the appropriate PC for which the particular packet of network traffic is intended. Translation is required because multiple computers are accessing the Internet through only a single connection. As such, NAT must keep track of the identities of the PCs making the request for information and route the information received from the Internet back to the appropriate PCs. Accordingly, the data received from the Internet through the gateway 123 is then routed to the PC that initiated the information request.

A particularly unique feature of this aspect of the invention is the ability of NAT to allow each PC 118, 120 to use its own ISP of choice to access the Internet using only the single connection 109 between the gateway 123 and CMTS 130. In particular, the gateway 123 receives the IP address from the first PC 118 and NAT translates the private IP address to the public IP address provided by the DHCP server 132. NAT is also able to translate the private IP address of the second PC 120 and associate that private IP address with a second public IP address generated the DHCP server 132. In operation, the gateway 123 accesses the CMTS 130 over connection 109. The CMTS 130 then looks at the source addresses from the gateway 123 and routes the information request to the selected ISPs 138, 140. Thus, each PC 118, 120 is able to access its ISP of choice at the same time.

The gateway 123 is configured such that before the CMTS 130 provisions any ISPs, NAT has only one public IP address which can only be used to access the provisioning server. It is to be noted that the provisioning server may be a standalone server or integrated into the CMTS 130. For purposes of this discussion, and as shown in the figure, the provisioning server is built into the gateway 123. The end user operating one of the PCs 118, 120 then uses a web browser, such as Microsoft's Internet Explorer or Netscape's Navigator, to access the CMTS 130 through the gateway 123 to provision an ISP. Note that any type of remote access method, such as telnet, may be used as well.

Once an ISP is provisioned, the gateway 123 must obtain a new IP address. It does so by having the provisioning server, such as the CMTS 130, send a simple network management protocol (SNMP) command to the gateway 123. The SNMP command forces the gateway 123 to release its current address and perform a renew function. When the DHCP server 132 renews the address, it provides the gateway 123 with a new IP address corresponding to the newly provisioned ISP. The proper address is obtained because the provisioning process configured the DHCP sever 132 with the media access control (MAC) address from NAT. On a LAN (or other network), the MAC address is the CPE device's unique hardware number. Thus, for example, when the PC is connected to the Internet, a correspondence table relates the IP address to the PC's MAC address on the LAN. Upon completion of the provisioning all the PCs 118, 120 access the Internet through the same ISP.

If an additional device, such as the second PC 120, needs to be configured with an alternate ISP, the PC operator opens a management window to the gateway 123 and requests a new ISP. NAT then binds the private address of the PC 120 that made the request for a public address. At this point, because the PC 120 is requesting provisioning of another ISP, the PC 120 can access only the provisioning server, such as the CMTS 130. It is to be noted that NAT can use a single MAC address and share it across multiple IP addresses or NAT can allocate another MAC. The choice of either a single or additional MAC address is dependent on the operation of the DHCP server 132 and whether it is able to handle one or both of the options. Preferably, in order to minimize the use of MAC addresses that NAT needs, it is desirable to share a single MAC address across multiple IP addresses.

After the new ISP is provisioned, the gateway 123 is reset. At that point the PC 118 is provisioned to the ISP originally selected and the PC 120 that provisioned the new ISP is connected to the new ISP. Any additional PCs that are in the LAN and connected to the gateway 123 can be configured in the same manner such that each additional PC has the capability to provision its own ISP of choice. It is to be noted that circumstances may arise where the original provisioning PC 118 itself may decide to provision an alternate ISP. In such cases there is no effect on other PCs that are accessing the Internet through the ISP originally provisioned by the first PC 118. Thus, regardless of whether the first PC 118 provisions a subsequent ISP, the other PCs on the network, unless choosing to do otherwise, continue to access the ISP that was initially provisioned.

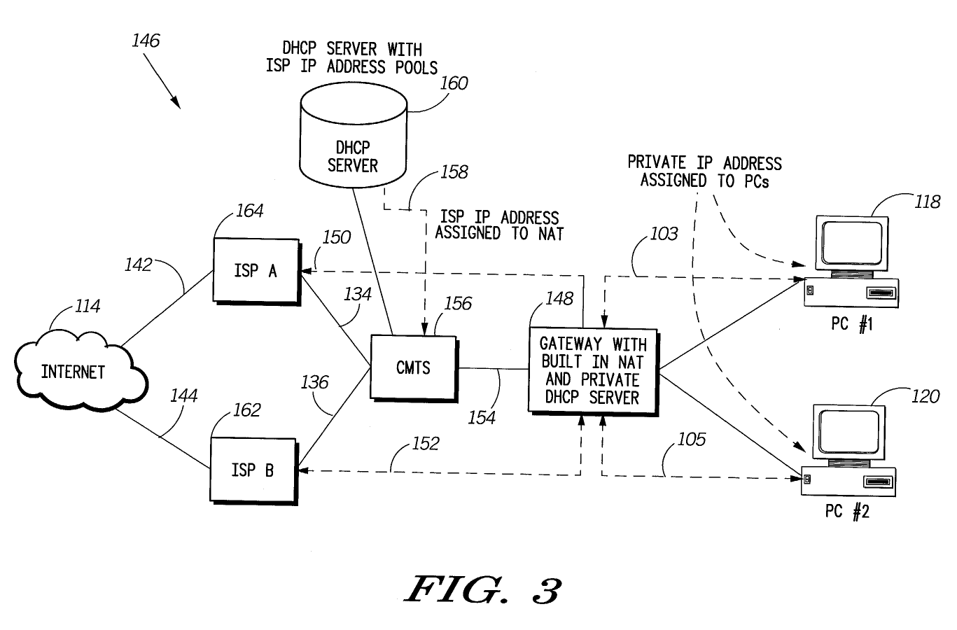

Turning now to FIG. 3, a network 146 in another aspect of the invention is shown. As described above, the network includes one or more PCs 118, 120 in a LAN connected to a gateway 148 through network connections 103, 105. The gateway 148 is connected to the CMTS 156 over connection 154. In this particular aspect, the PC 118, requesting provisioning of an ISP and accessing the gateway 148 to request a new ISP, is passed through to the CMTS 156. Accordingly, the gateway 148 does not receive the IP address from the DHCP server 160. Instead, the CMTS 165 receives the newly allocated IP address from the DHCP server 160. The CMTS 156 then accesses the gateway 148 and provides it with the new IP address obtained from the DHCP server 160. The gateway 148 upon receiving the new IP address is forced to release the current address and to perform a renew action, wherein the gateway 148 receives a new IP address. This is caused by the provisioning server, such as the CMTS 156, sending an SNMP command to the gateway 148 requesting the renewal. When the DHCP server 160 renews the address over connection 158 to the CMTS 156, the CMTS 156 provides an IP address for the newly provisioned ISP to the gateway 148. The first PC 118 is then able to access the Internet 114 by connecting to the selected ISP 164 over connection 150. At this point, once the first PC 118 provisions the selected ISP 164, all the PCs on the network access the Internet through the same ISP.

As before, if desired the second PC 120, or any other device on the network, including the first PC 118, may request that a second or alternate ISP be provisioned. Accordingly, the device requesting provisioning of a second ISP, such as the second PC 120, accesses the gateway 148 through a management window, is passed through to the CMTS 156 and there provisions the second ISP. Subsequently, the gateway sends a command to the CMTS 156 over connection 154 to provision the newly requested ISP. The DHCP server 160 then provides the CMTS 156 over connection 158 an IP address for the newly requested ISP. After the new ISP is provisioned, the gateway 148 is reset such that the PC 120 or other device requesting the newly provisioned ISP accesses the Internet 114 through the newly selected ISP 162. As a result, the devices initially accessing the Internet through the originally provisioned ISP 164 continue to be connected to the originally provisioned ISP 164 and the second PC 120 is connected to the newly provisioned ISP. Any additional PCs that are in the LAN and connected to the gateway 148 are able to operate in the same manner.

In another aspect, the gateway 123 is provided without including NAT functionality. As such, the gateway 123 is configured to support IP forwarding to enable CPE devices on other gateway ports and other subnets to communicate.

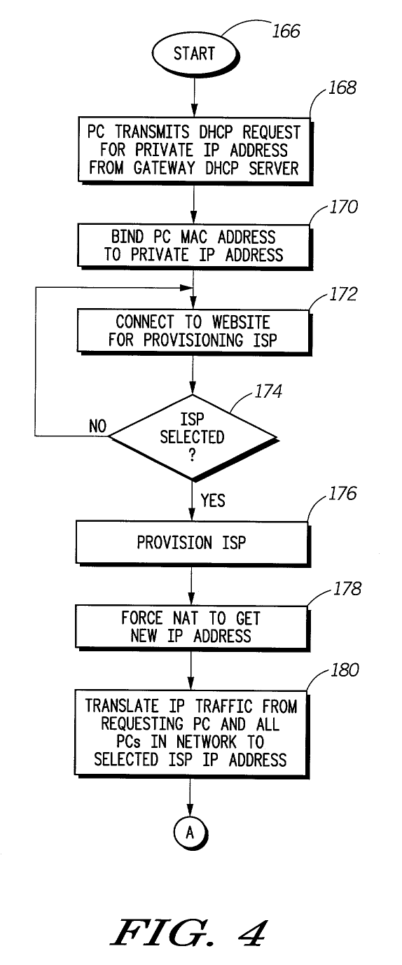

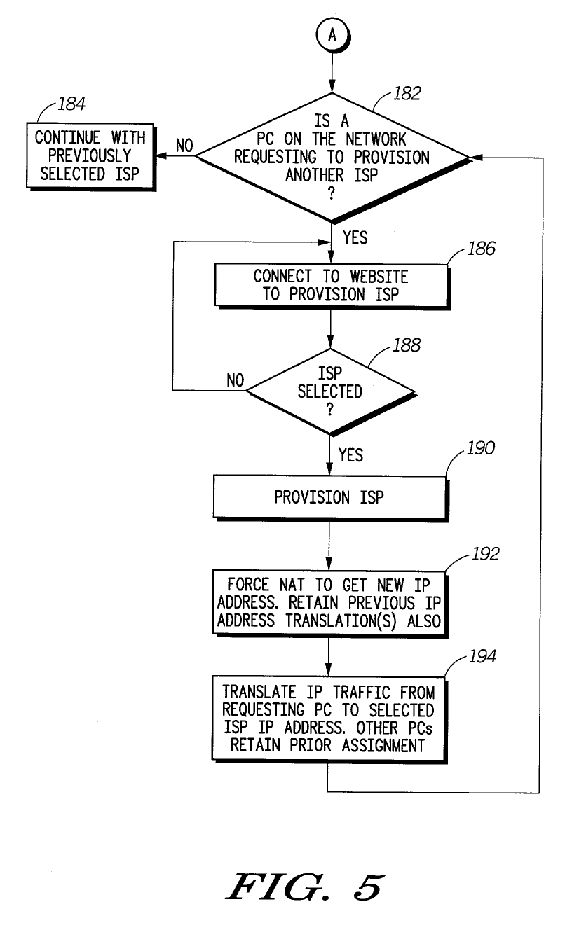

Referring now to FIG. 4 the ISP provisioning process 166 is shown in operation. When the LAN is initially booted, the gateway provides only private IP addresses to the PCs connected in the LAN. In particular, as part of the communication procedure within the LAN, each PC transmits a DHCP request for a private IP address from the gateway DHCP server in step 168. Each PC is then provided a unique private IP address that uniquely identifies the PC requesting the IP address. The IP addresses are then used by the PCs to identify each other as they communicate with other PCs on the private network and with the gateway.

Upon requesting the private IP address from the gateway, the CPE device's or PC's MAC address is bound to the private IP address in step 170. When a PC attempts to connect to the Internet in step 172, the PC is connected to the gateway website for provisioning an ISP. As mentioned above, ISP provisioning may be accomplished using a management control window or some other type of remote access method. Once an ISP is selected in step 174, the CMTS provisions the ISP in step 176. If no ISP is selected, the PC requesting Internet access waits at the gateway website until an ISP is chosen or until the PC moves on to a different task.

After the ISP is provisioned in step 176, the NAT function is forced by the CMTS in step 178 to get a new IP address. NAT then translates IP traffic from the requesting PC and all PCs located in the network to the selected ISP address in step 180. After the initial ISP is provisioned, a second PC in step 182 may then request that another ISP be provisioned. If no such request is made, then in step 185 all the PCs on the network continue to operate with the previously selected ISP.

If, however, the second PC requests another ISP, the second PC that is requesting to provision another ISP is connected in step 186 to the gateway website that provisions ISPs. Once the PC selects another ISP in step 188, the requested ISP is provisioned in step 190. Accordingly, NAT is once again forced by the CMTS to get a new IP address for the PC requesting the new ISP. NAT, however, retains the previous IP address translations selected in the prior ISP provisioning steps. Thus, the gateway in step 194 translates IP traffic from the requesting PC to the selected ISP IP address. The other PCs retain their prior IP assignment. As a result, it can be seen that each PC in the LAN is able to have its own choice of ISPs, notwithstanding the fact that the network has only a single connection to the Internet.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

What is claimed is:

1. A system for accessing multiple Internet service providers using a single connection to the Internet, comprising:
a source routing device;
at least two customer premise equipment devices connected in a network configuration;
a gateway for controlling communication between the source routing device and the customer premise equipment devices; and
an address server for providing the gateway with at least two dynamically assigned Internet protocol addresses corresponding to different Internet service providers to enable each of the customer premise equipment devices to establish simultaneous connections with the different Internet service providers.

2. The system of claim 1, wherein the gateway controls communication between the customer premise equipment devices.

3. The system of claim 1 wherein the source routing device is a cable modem termination system.

4. The system of claim 1 wherein the address server is a dynamic host configuration protocol server.

5. The system of claim 4 wherein the dynamic host configuration protocol server provides the gateway with dynamically assigned Internet protocol addresses.

6. The system of claim 1, wherein the gateway uses network address translation for controlling communication between the source routing device and the customer premise equipment devices.

7. The system of claim 1, wherein the gateway enables the customer premise equipment devices to request provisioning of an Internet service provider.

8. The system of claim 7 wherein the gateway allows the customer premise equipment devices to access only the provisioning server when the customer premise equipment is requesting access to an Internet service provider.

9. The system of claim 1, wherein the source routing device includes a provisioning server for provisioning Internet service providers.

10. The system of claim 7, wherein the customer premise equipment device uses a management window to access the gateway to request provisioning of an Internet service provider.

11. In a communications network comprising a gateway for controlling communications between at least two private devices in a local area network located in a private space and at least two public devices in a wide area network located in a public space using a single connection between the gateway and the wide area network, a method for accessing multiple internet service providers comprising:
receiving at least two Internet protocol addresses from an address server located in the public space, wherein the Internet protocol addresses correspond to the at least two public devices connected in the wide area network; and
establishing simultaneous connections between at least two private devices connected to the local area network with the at least two public devices connected to the wide area network, wherein the at least two public devices are Internet service providers.

12. The method of claim 11, further including the steps of:
accessing a provisioning server to request a connection to an Internet service provider;
provisioning the requested first Internet service provider;
repeating the accessing and provisioning steps as required to enable additional private devices to communicate with additional Internet service providers.

13. The method of claim 12, wherein the accessing step includes opening a management window on the private device to request provisioning.

14. The method of claim 12, wherein the provisioning server is a source routing device.

15. A gateway for controlling communications between a local area network located in a private space and a wide area network located in a public space using a single connection between the gateway and the wide area network, the gateway comprising:
a network address translator configured to receive at least two Internet protocol addresses from the public space and to enable simultaneous connections between at least two private devices connected to the local area network and at least two public devices connected to the wide area network.

16. The gateway of claim 15, wherein the at least two public devices comprise at least two Internet service providers.

17. The gateway of claim 15, wherein the network address translator binds the private addresses of the devices located within the private space to the public addresses of the devices located in the public space.

18. A system for accessing a selected one of a plurality of Internet service providers using a single connection to the Internet, the system comprising:
a source routing device;
a customer premise equipment device;
a provisioning server for provisioning an Internet service provider selected by the customer premise equipment device; and
an internet protocol address server having a plurality of addresses corresponding to the plurality of internet service providers for allowing the customer premise equipment to select one of the internet service providers with the internet protocol address server providing the gateway with one of the plurality of addresses corresponding to the selected internet service provider to enable the customer premise equipment device to communicate with the internet service provider.

19. The system of claim 18, wherein multiple customer premise equipment devices each access the internet protocol address server to select one of the plurality of internet service providers for enabling each of the customer premise equipment devices to communicate with its internet service provider of choice.

20. The system of claim 18, wherein the provisioning server is a gateway server having a network address translator for enabling simultaneous connections between at least two customer premises equipment devices connected in a local area network and at least two internet service providers connected in a wide area network.
